(19) United States
(12) Patent Application Publication
(10) Pub. No.: US 2025/0180884 A1
(43) Pub. Date: Jun. 5, 2025

(54) Microscope

(71) Applicant: Carl Zeiss Microscopy GmbH, Jena (DE)

(72) Inventors: Tiemo Anhut, Jena (DE); Daniel Schwedt, Weimar (DE)

(21) Appl. No.: 18/968,669

(22) Filed: Dec. 4, 2024

(30) Foreign Application Priority Data
Dec. 5, 2023 (DE) 10 2023 134 043.3

(51) Int. Cl. G02B 21/00

(52) U.S. Cl. CPC G02B 21/0064; G02B 21/0036

(57) ABSTRACT

A microscope comprising an illumination beam path for guiding excitation light onto and/or into a sample a detection unit for detecting light emitted from the sample, and a detection beam path with a microscope objective for guiding at least a portion of the light emitted from the sample to the detection unit. In the detection unit, a first detection channel with at least one first detector and at least one further detection channel are formed, with each further detection channel comprising at least one detector. The detection unit includes at least one beam splitter in each case for guiding a portion of the light emitted from the sample into a respective further detection channel. At least one of the detection channels includes a manipulation device for axial displacement of a focal region in order to image axially spaced sample planes in at least two detection channels.

The current application claims the benefit of German Patent Application No. 10 2023 134 043.3, filed on 5 Dec. 2023, which is hereby incorporated by reference.

The invention relates to a microscope having the features of the preamble of claim 1.

A generic microscope is known from DE 10 2020 120 190 A1 and comprises the following constituent parts: A light source for transmitting excitation light, an illumination beam path for guiding the excitation light onto and/or into a sample, a scanning device for varying a location on and/or in the sample exposed to the excitation light, a detection unit for detecting the light emitted from the sample, a detection beam path with a microscope objective for guiding at least a portion of the light emitted from the sample to the detection unit and a control unit for controlling the scanning device and the detection unit and for evaluating measurement data from the detection unit.

Confocal microscopy is a commonly used method for examining small biological structures by imaging. It is possible to image single cells in biological tissue, extending to imaging in live animals. The aspect of background suppression, and hence the possibility of achieving a three-dimensional image structure, in particular is important here.

A core problem of confocal microscopy lies in its slow image build-up, which is due to the fact that every point of the sample has to be scanned by a laser spot and the associated detection. This happens sequentially and thus slowly. In particular, there is a significant time difference between the imaging of different measurement planes, since two-dimensional images are usually recorded in each plane and there is a step in the axial direction following the respective image. The image stack can then be represented pseudo-three-dimensionally or in sections and projections, for example.

The ability to measure not only in one plane, but in multiple planes at the same time, is of interest for various measurement tasks.

Another problem associated with the fundamental method of recording is that the high intensities that need to be focused in a small area of the sample lead in part to significant bleaching of, and photodamage to, the sample.

Higher speeds can be achieved by using resonant scanners, which can then scan relatively large image fields quickly. Disadvantages of this method result from the then very short pixel time, in which a sufficiently good signal must be generated. For example, approx. 10 detected photons per measurement point are required should the intention be to achieve a signal-to-noise ratio of 3. 30 emitted photons are required in 50 ns assuming both a total detection efficiency of about 33% and an average pixel dwell time of 50 ns, and this corresponds to a photon emission rate of 600 MHZ. This is only possible with very bright and stable samples.

Furthermore, it is possible to achieve a higher speed by using various approaches for parallelizing the recording of the image by scanning with more than one confocal volume. Various parallelization techniques are possible here. Lateral (e.g. DE 10 2016 102 286.1) and axial [1], [2] multispot methods and multispot methods within the point spread function [3] are known. Laterally resolving methods based on a lateral multiplication of the point spread function (PSF), so-called multispot methods, require a relatively high level of apparatus complexity.

Axially parallel methods are equally complex and/or inflexible. The distance between the planes is often fixed in these approaches, [2]. In [1], the size of the confocal slit, which is given here by a reflective structure, is also fixed. This is disadvantageous because the pinhole/slit size depends significantly on the wavelength and the selected objective, and this parameter is also used to optimize between axial resolution, background suppression and signal strength. In [2], the pinholes appear to be more flexible. However, they are at fixed positions and given by physical pinholes, which can be expensive. Displacing the pinhole position appears complicated in this case. In addition, they must be matched to the illumination with the diffractive element, and this renders the use thereof in a multi-colour experiment questionable.

One problem addressed by the invention can be considered that of specifying a microscope that can be used to record three-dimensional images of a sample particularly quickly.

This problem is solved by the microscope having the features of claim 1.

According to the invention, the microscope of the aforementioned type is developed in that in the detection unit, a first detection channel with at least one first detector and at least one further detection channel are formed, with each further detection channel comprising at least one detector, in that in the detection unit, at least one beam splitter is present in each case for guiding a portion of the light emitted from the sample into a respective further detection channel, and in that in at least one of the detection channels, a manipulation device is present for axial displacement of a focal region in order to image axially spaced sample planes in at least two detection channels.

Advantageous exemplary embodiments of the microscope according to the invention are explained below, especially in the context of the dependent claims and the figures.

The essential concept underpinning the microscope described herein is that of an axial parallelization of detection, especially confocal detection.

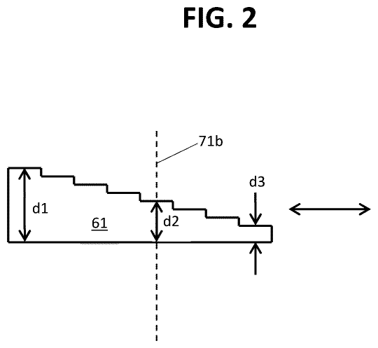

One starting point for the invention can be considered to be the insight that the gradient colour splitter 23, which in the detection arrangement of FIG. 2 in the earlier application DE 102023100926.5 serves to steer light of different wavelengths to different sensors in each case, can advantageously also be replaced by a neutral-intensity splitter, which distributes a proportion to each sensor, e.g. 50%/50%.

Achieving an axial offset in the various detection channels by arranging in at least one of the detection channels a manipulation device for axially displacing a focal region can be considered to be a further essential concept.

The excitation light is electromagnetic radiation, in particular in the visible spectral range and adjoining ranges. The only demand placed on the contrast-providing principle by the present invention is that the sample emits emission light as a consequence of the irradiation by the excitation light and/or deflects, scatters or reflects back the excitation light. Typically, the emission light is fluorescence which the sample, in particular dye molecules present there, emits or emit as a consequence of the irradiation by the excitation light.

At least one light source, for example a laser, is present for the provision of the excitation light. The spectral composition of the excitation light can be adjustable, in particular between two or more colours. The excitation light can also simultaneously be polychromatic, for example if different dyes are intended to be detected simultaneously.

The term “illumination beam path” denotes all optical beam guiding and beam modifying components, for example a microscope objective, lenses, mirrors, prisms, gratings, filters, stops, beam splitters, modulators, for example spatial light modulators (SLM), by means of which and via which the excitation light from the light source is guided up to and/or into the sample to be examined. Beam modifying components also include dispersive and, in particular, diffractive elements that cause optical dispersion, for example structures such as gratings or volume holograms that may in part have a spatially periodic structure in particular.

Light that is transmitted and/or deflected, for example scattered, by the sample to be examined as a consequence of the irradiation by the excitation light can be referred to as emission light and reaches the detection unit via the detection beam path.

The term “detection beam path” denotes all beam guiding and beam modifying optical components, for example objectives, lenses, mirrors, prisms, gratings, filters, stops, beam splitters, modulators, e.g. spatial light modulators (SLM), by means of which and via which the emission light is guided from the sample to be examined to the detectors. The microscope objective is part of the detection beam path.

Imaging the sample means that at least part of the sample is imaged. The visible region is delimited by the field of view of the sensor and/or by field stops optionally present in the detection beam path.

The term “control unit” denotes all hardware and software components which interact with the components of the microscope according to the invention for the intended functionality of the latter. In particular, the control unit can comprise a computing device, for example a PC, and a camera controller capable of rapidly reading out measurement signals. The computer resources of the control unit can be distributed among a plurality of computers and optionally a computer network, in particular also via the Internet. The control and evaluation unit can comprise in particular customary operating equipment and peripherals, such as a mouse, keyboard, screen, storage media, joystick, Internet connection. The control unit can in particular read the image data from the detector and can also be configured and serve to control the light source.

In typical exemplary embodiments, the illumination beam path and/or the detection beam path in the microscope according to the invention comprises at least one of the following components: main beam splitter, scanning optical unit, tube lens. Parts of the illumination beam path and the detection beam path can be provided by the same optical components. A beam splitter that separates excitation light from emission light, i.e. from light emitted by the sample, is referred to as a main beam splitter. Typically, the detection beam path thus contains hardly any or no components of excitation light downstream of the main beam splitter. The detectors in the detection unit therefore cannot be swamped by excitation light. The main beam splitter can be a dichroic beam splitter.

The sample can be illuminated using a separate optical unit, in particular via a separate microscope objective. In many arrangements, however, the sample is illuminated by one and the same microscope objective, which is also a constituent part of the detection beam path.

The scanning device may comprise a two-dimensional scanner arranged in the illumination beam path. This scanner can also be a constituent part of the detection beam path, i.e. the light to be detected, which is emitted from the sample, is de-scanned, and the detection unit can be arranged in the de-scanned beam path. For example, the two-dimensional scanner can be a quasi-static scanner. Resonant scanners can also be used should the intention be to obtain higher scan speeds. In an alternative to that or preferably in addition, the scanning device may comprise a controllable laterally displaceable sample stage. The sample stage can advantageously be laterally displaceable in two independent coordinate directions, each perpendicular to a direction of an optical axis of the microscope objective. The scanning device can also be realized by a combination of a two-dimensional scanner with a laterally displaceable sample stage. Resonant and quasi-static scanners can each be designed as galvanometric scanners, as MEMS scanners or as any other type of scanner.

In a preferred exemplary embodiment, the detection unit comprises an aperture stop with adjustable size. The aperture stop can perform two functions. Firstly, out-of-focus emission light can be stopped down thereon, and, secondly, it acts as an entrance opening for a spectrally dispersive mode that is described in detail below. In the spectrally resolving or dispersive mode, the size of the entrance opening influences the spectral resolution and, should multiple spectral detection channels be present, the separation of the detection channels. Advantageously, an entrance optical unit may also be present in order to create an intermediate image plane in which the aperture stop can be positioned.

In the detection unit, an optical unit of variable focal length is present for imaging the sample with variable magnification onto the detectors in a particularly preferred exemplary embodiment. Firstly, the optical unit of variable focal length can serve to set the distance or the distances between the sample planes imaged in the various channels; this will be explained in detail below. Furthermore, the optical unit of variable focal length can serve to adapt the imaging to a pixel grid of two-dimensionally spatially resolving detectors.

In a particularly preferred exemplary embodiment, the optical unit of variable focal length in each case images one and the same plane of the sample onto a detector or a plurality of detectors, independently of a focal length setting. This achieves the advantage that the detector or the detectors can in each case remain at the same location independently of the setting of the optical unit of variable focal length.

The optical unit of variable focal length can be formed by a zoom optical unit. The advantage achieved in this context is that the magnification of the imaged sample plane can be adjusted particularly finely. In particular, the magnification can be set particularly precisely to an advantageous value in view of the parameters of a pixel spacing of the used detectors and in view of the extent of the point spread function.

The control unit can also be configured to adjust the magnification using the optical unit of variable focal length.

The term “point spread function” refers to the intensity distribution of the light created by e.g. a lens from an incoming parallel beam that fills a specific used diameter of the lens. This function is routinely abbreviated PSF (point spread function). The used diameter of the lens used may but need not be the maximum possible diameter. This means that the PSF need not correspond to a full use of the maximum numerical aperture available. Should the numerical aperture not be fully utilized, the extent of the PSF, especially in the axial direction as well, is increased in comparison with the maximum utilization.

However, it is also possible that the optical unit of variable focal length is formed by a lens interchange system, by means of which the magnification can be set to a plurality of discrete values. This may be sufficient for many applications.

The possibility of a high-quality simultaneous recording of two or more planes of the sample should be considered to be the first important advantage of the microscope according to the invention.

Thereupon, distances between the various scanned planes can be set very easily but still very precisely in the microscope according to the invention.

Furthermore, a fully confocal operation is possible with the microscope according to the invention. In particular, the sizes of effectively effective confocal pinholes, which need not necessarily be physical stops, can be set on an individual basis in each detection channel, and thus for example on an individual basis for different observed sample planes.

With the arrangements described here, image scanning microscopy can also be performed, wherein the variation of a binning is equivalent to adjusting the size of the confocal pinhole. This will be described in detail below.

The recording of one and the same plane with different sized pinholes, and consequently with different binning, which is possible with suitable spatially resolving detectors by way of an appropriate readout, can be advantageous, for example in order to increase the contrast or improve the axial resolution. This would be possible if the spatially resolving detectors were subjected to the same spectral content in both channels, i.e. by use of a neutral-density filter. In addition, it expedient to choose differently sized pinholes in the event of very different emission wavelengths because the cross section of the point spread function is linearly dependent on the central wavelength.

The microscope according to the invention also allows a simple reconfiguration from a multi-colour system (multi-channel system), which records data from the sample in only one plane, to a multi-plane system.

All imaging and measurement modes that can be performed in one plane with the system can be extended to two or more planes without any further modifications (confocal imaging, airyscan/image scanning, MPLX, single shot 3D, Dynamics Profiler).

A particularly simple exemplary embodiment of the microscope according to the invention is characterized in that in at least one of the detection channels, the manipulation device comprises a glass plate arranged in a convergent part of the detection beam path.

The distance of the planes of the sample imaged on the detectors depends both on the angular spectrum of the light incident on the glass plate and on the thickness of this plate. As an approximation, for small non-zero convergence angles of the beam, the axial offset Dz is described by the thickness d of the plate and the refractive index n of the plate material as follows:

$$D z = d \times ( n - 1 ) / n$$

With the lateral magnification V from the sample space to the image region of the detection, this axial displacement Dz in the image region is converted into the sample space in the form of an axial offset dz in the sample space, according to:

$$d z = Dz / ( V \times V )$$

Greater flexibility in view of possible different axial offsets is possible when an adjustable component is used. For example, in at least one of the detection channels, the manipulation device may comprises a stepped glass plate that is arranged in a convergent part of the detection beam path, said stepped glass plate being variably positionable in the detection beam path in order to set different optically effective thicknesses transverse to an optical axis.

In at least one of the detection channels, the manipulation device in an alternative to that or in addition can comprise an interchanger with different glass plates that is arranged in a convergent part of the detection beam path, the glass plates having different thicknesses and/or the glass materials of the glass plates having different refractive indices.

Even finer adjustments of the axial position of a sample plane imaged in a particular detection channel are possible if the manipulation device comprises two glass wedges to be arranged in a convergent part of the detection beam path, said glass wedges being displaceable relative to each other and relative to an optical axis in order to set different optically effective thicknesses continuously.

In an alternative to that or in addition, it is finally also possible that in at least one of the detection channels, the manipulation device comprises a mini-telescope, in particular an adjustable mini-telescope.

Components of the types described here each can be present in only one detection channel, in a plurality of detection channels or in all detection channels. The respective manipulation devices can be controlled by the control unit, and so the user can e.g. select the spacing of the axial planes. The spacing of the planes in the sample imaged in the detection channels in each case can be obtained by varying the thickness d and/or the magnification V, in particular by using the optical unit of variable focal length, for example a zoom optical unit.

Since defocusing is always implemented in one direction only by the above-described manipulation devices for axially displacing a focal region, in particular by the addition of paths in glass, it may be expedient for the device for setting an axial depth of illumination to also be configured to defocus the excitation light in such a way that a focus of an excitation beam, in particular in the middle, is located between two detection planes and in particular between the two detection planes most distant from each other.

In addition to that or in an alternative, however, an additional optical component may also be present, the latter providing a defocusing in the opposite direction to the direction of defocusing caused by the addition of paths in glass.

From a practical point of view, it is important that the magnification from the sample to the two-dimensionally resolving detector can vary greatly when using an optical unit of variable focal length, for example a zoom optical unit.

For example, the total magnification can be 100. A path difference in glass of 3 mm, a feasible size, is required to set a spacing of the planes of 100 nm at a total magnification of V=100, which is approximately equivalent to an axial Nyquist scan for high-NA objectives.

However, significantly larger magnifications up to V=1000 are possible for microscopic modes where the point spread function is greatly magnified, for example imaged on the two-dimensionally resolving detector in such a way that the cross section of the point spread function extends over a few pixels, for example 5 or more pixels (Zeiss: “Airyscan” mode). That case would require path differences in glass of 300 mm, which is not realistic. For such modes in particular, it may be advantageous for a further component for setting the focal length, for example an adjustable lens, in particular an electro-optically adjustable lens, or a varifocal lens, to be present in a detection channel between the beam splitter and at least one two-dimensional resolving detector.

A combination of a glass plate and a variably adjustable lens can also be advantageous because an adjustable lens in particular is often unable to set low refractive powers well with the desired precision.

In order to achieve illumination of the sample in an axially extended region, a unit for setting an axial depth of illumination is present in the illumination beam path in a further preferred configuration of the microscope according to the invention.

In a simple variant, the numerical aperture of the illumination can advantageously be reduced somewhat in order to axially lengthen the distribution of the excitation light and at least extend it over the detected planes. For example, this can be achieved by reducing a diameter of a stop situated in the illumination beam path. Thus, the unit for setting an axial depth of illumination preferably comprises an adjustable stop for setting a beam diameter of the excitation light.

A similar effect, i.e. a lengthening of the axial distribution of the excitation light and its extent over the detected planes, is possible in configurations in which the unit for setting an axial depth of illumination comprises at least one diffractive component.

In view of obtaining illumination of the different axial planes with an intensity that is as similar as possible, even better properties can be achieved, albeit with greater effort, in embodiments in which the unit for setting an axial depth of illumination is configured to generate a plurality of axially spaced focal points in the sample. For example, this is possible using a diffractive optical element (DOE).

A further particularly preferred exemplary embodiment is distinguished in that a further optical beam shaping unit is present in front of a main beam splitter in the illumination beam path in the direction counter to the propagation direction and/or in front of a, or the, main beam splitter in the detection beam path in the direction of the propagation direction, said further optical beam shaping unit serving to generate special forms of the point spread function, in particular an axially coded point spread function, for example a helical point spread function, an astigmatic point spread function or a “twisted” point spread function.

Axially coded means that the beam cross section perpendicular to the optical axis, i.e. perpendicular to the z-axis, has a shape and/or orientation that is dependent on the z-coordinate, and consequently on the depth coordinate.

Axially coded beams can be utilized to obtain depth information, i.e. for 3-D techniques. “Single-shot” techniques are examples of such 3-D techniques; they are called thus because illuminating a single point in the xy-plane of the sample allows microscopic information about the sample at the location (x, y) to be obtained for a plurality of values of the z-coordinate.

One example is described in DE 10 2017 119 531 A1.

The beam shaping unit may preferably comprise one or more of the following components: diffractive optical element, spatial light modulator (SLM), adjustable lens, phase plate.

For example, the beam shaping unit may be arranged in the detection beam path between a pinhole optical unit and the optical unit of variable focal length or between the optical unit of variable focal length and the beam splitter. In the illumination beam path, the beam shaping unit may be arranged, for example, between the unit for setting an axial depth of illumination and a main beam splitter.

It is also possible that the unit for setting an axial depth of illumination provides the functionality of the beam shaping unit under discussion here.

There is freedom of design in view of the specific configuration of the beam splitters.

In an important group of exemplary embodiments of the microscope according to the invention, at least one of the beam splitters is a neutral-intensity splitter. It is also possible that a plurality of beam splitters or all beam splitters are neutral-intensity splitters. Two detection channels, which are formed from an incoming beam by a neutral-intensity splitter, can be used for imaging two different axial planes if a manipulation device for axially displacing a focal region is present in at least one of the two detection channels and the axial positions in the sample planes imaged by two detection channels differ. Provided that the neutral-intensity splitter is ideally neutral, light of the same wavelength spectrum is detected in the two detection channels if said two detection channels do not contain different components, such as filters, and/or if no measures that have a different effect on the spectrum of the light to be detected are taken.

Particularly advantageous applications of the microscope according to the invention are possible if at least one of the detectors is a two-dimensionally spatially resolving detector, in particular a camera chip, particularly preferably a SPAD array. It is also possible that a plurality of detectors or all detectors are two-dimensionally spatially resolving detectors, in particular SPAD arrays. In that case, it is also possible that a plurality of the detectors are formed by one and the same camera chip, for example by one and the same SPAD array. In particular, the SPAD arrays can be operated in a single photon counting mode (Geiger mode), which is advantageous in view of the signal-to-noise ratio. Spatially resolving means that each pixel of the two-dimensionally spatially resolving detector can be read out separately.

Variable pinholes can be realized using such detectors or array sensors, i.e. the detectors can represent electronically adjustable pinholes. This is particularly advantageous in connection with the optical unit of variable focal length, for example the zoom system or another adjustable optical unit, with which a size of a pinhole can be roughly adjusted. Then again, the optical unit of variable focal length can serve to match the PSF to the respective detector such that a dynamic range of the detector can be optimally used. By electronically setting the detectors, each axial plane can moreover be assigned its own pinhole with an individualized size, i.e. the degree of confocality can be set on an individual basis for the respective detection channel. This allows the system overall to operate in a confocal mode and the background suppression is as good as it is known from a confocal system.

It is particularly advantageous if in at least one of the two-dimensionally spatially resolving detectors, pixels, in particular adjacent pixels, for example adjacent pixels in the direction of the detector rows and/or detector columns and in particular pixels adjacent perpendicularly to the direction of dispersion, can be combined by binning. This enables important advantages in view of data rate and measurement speed.

Further improvements in this respect can be achieved if in at least one of the two-dimensionally spatially resolving detectors, pixels can be individually set either actively or passively. Passive means that no measurement information is generated and/or read from passively set pixels.

Pixelated detectors, in particular SPAD array detectors, usually have a fill factor of less than 1, which means that the detectors have regions between the pixels where photons incident thereon are not detected. Consequently, the detectors can detect incident photons only on a fraction of the detector surface. To compensate for this property, the detector can be provided with a microlens array, wherein each pixel, for example each SPAD pixel, may be assigned a microlens. A more effective entrance of the light to be detected into a two-dimensionally spatially resolving detector is thus possible if a multi-lens array is arranged in front of the relevant detector.

In alternative configurations, at least one of the detectors comprises one or more photomultipliers, in particular with an adjustable entrance pinhole. It is also possible that a plurality of detectors or all detectors each comprise one or more photomultipliers, in particular each with an adjustable entrance pinhole.

Mixed forms are also possible in which for example SPAD arrays are arranged in some detection channels and photomultipliers are arranged in some detection channels.

A particular advantage of the microscope according to the invention is that light with different wavelength spectra can also be detected in the different detection channels without much outlay.

Another important group of exemplary embodiments of the microscope according to the invention is characterized in that at least one of the beam splitters is a colour splitter which forms at least two spectrally different detection channels. It is also possible that a plurality of beam splitters or all beam splitters are colour splitters.

In at least one of the detection channels, a dispersive device is particularly preferably present in that case, for spectrally separating at least a portion of the light emitted from the sample.

The control unit can also be configured for controlling the dispersive device or devices.

Two detection channels formed by a colour beam splitter from an incoming beam can serve to image two parts of a wavelength spectrum of the light emitted from one and the same axial sample plane should the axial positions of the sample planes imaged in the two detection channels be the same.

However, it might also be preferable to use two detection channels formed by a colour beam splitter from an incoming beam for imaging a first part of the wavelength spectrum from a first sample plane and a second part of the wavelength spectrum from a second axial sample plane axially spaced from the first sample plane.

As in the situation described above for the neutral-intensity splitter, this requires the presence in at least one of the two detection channels of a manipulation device for axially displacing a focal region and differing axial positions of the sample planes imaged in the two detection channels.

Advantageously, a dispersive device for spectrally separating light to be detected, effective in a plurality of detection channels, can be present.

A microscope that can be used particularly flexibly is obtained should at least one dispersive device, or a plurality or all of the dispersive devices, for spectrally separating at least a portion of the light emitted from the sample be controllable and optionally activatable, and should the control unit be configured to control the at least one dispersive device in each case.

For example, at least one dispersive device for spectrally separating light to be detected may comprise at least one of the following components or be formed by one of the following components: a grating that can be pivoted into the detection beam path, in particular transmission grating or reflection grating, a prism that can be pivoted into the detection beam path, in particular an Amici prism or Pellin-Broca prism.

In microscopy, it is generally desirable to obtain reasonable grey values for the images to be recorded. In other words, the aim is to make reasonable use of the capacity of detectors used, i.e. operate these neither in the range of saturation, where the proportionality of the measuring signal to the amount of light is lost, nor at very low counting rates, where the signal is small in comparison with detector noise and the signal-to-noise ratio is not good.

In this respect, it should also be noted that the count rate of the detector elements (pixels) used is typically limited to a few megahertz and to a few 10 MHz at best. For SPAD arrays, the physical reason for the limited count rate lies in the photon-counting nature of the SPAD pixels with their inherent dead time during the detection process and moreover their dependence on the type of avalanche quenching. In order to obtain reasonable grey values in the generated images at pixel dwell times of approximately 1 microsecond or less typical for laser scanning microscopy, it may therefore be advantageous to distribute the emission of a dye among a plurality of pixels of the detector. To a certain extent, this is already achieved by spectral dispersion. Further improvements are possible in this respect in a further particularly preferred exemplary embodiment, in which in the detection unit and/or in at least one detection channel, a cylindrical optical unit that can optionally be introduced into the detection beam path is present, said cylindrical optical unit axially displacing an image plane in a direction that is perpendicular to a direction in which the dispersive device of the respective detection channel causes the spectral splitting. The axial displacement of the image plane, consequently in the direction of the optical axis, causes the light of a wavelength range to be detected to be distributed among a plurality of pixels of the detector.

In extreme cases, the light of a wavelength range to be detected can be distributed among all pixels in the relevant row or column of the detector. The cylindrical optical unit that can be introduced, in particular pivoted in, can be used to defocus the PSF in the axis oriented perpendicular to the dispersion direction and thus extend said PSF over many pixels on the detector.

Only a single cylindrical optical unit that can optionally be introduced might be present; it can be arranged in the detection beam path in front of a colour splitter or a plurality of colour splitters in the direction counter to the propagation direction. This cylindrical optical unit then acts on all spectral channels together. In another advantageous variant, a separate cylindrical optical unit that can optionally be introduced is present in each of a plurality of detection channels or in each individual detection channel. The distribution of the PSF among the pixels of the detector can then be implemented on an individual basis in the corresponding channels or in each channel. If need be, different cylindrical optical units can also be used in the various detection channels. At least one of the cylindrical optical units may comprise at least one cylindrical lens or may be realized by at least one cylindrical lens.

In an alternative to that or in addition, in at least one detection channel, a cylindrical optical unit that can optionally be introduced into the detection beam path is present, said cylindrical optical unit axially displacing an image plane in a direction that is perpendicular to a direction in which the dispersive device or one of the dispersive devices causes a spectral splitting.

In a further preferred embodiment of the invention, the detection unit and/or at least one of the detection channels comprises a filter that is adjustable in relation to its spectral transmission and/or reflection properties. This filter can serve to set the spectral detection bandwidths for ISM, for example, and limit them to the dyes selected in each case.

In this case, it is particularly preferable for at least one of the filters to have a setting in which the light is transmitted and/or reflected over a broad bandwidth. This setting can then advantageously be selected for spectrally resolving measurement modes. For example, at least one of the filters may have a plurality of discrete filter segments, each of which can be introduced into the detection beam path. In an alternative to that or in addition, at least one of the filters may be realized by a continuously adjustable filter in a different embodiment.

In a further particularly preferred configuration, an adjustable optical unit for laterally displacing spectrally separated light relative to the detector of the respective detection channel is present in the detection unit and/or in at least one detection channel. With the adjustable optical unit for laterally displacing spectrally separated light, the offset of a partial spectrum in a detection channel on the detector of this detection channel can be adjusted particularly advantageously.

The adjustable optical unit for lateral displacement may comprise at least one of the following components in the detection unit and/or in at least one detection channel or be realized by one of the following components: adjustable tiltable mirror, adjustable tiltable plane-parallel transparent plate, in particular glass plate. This allows for an optimal offset of a spectral range in each case relevant to the excited fluorophores on each of the individual detector sensors.

The mechanical manipulation of components in the beam path, such as pivoting in and out, pushing in, pulling out of the beam path and tilting, can be realized by controllable motorized drives.

Further features and advantages of the microscope according to the invention are explained below in connection with the figures, in which:

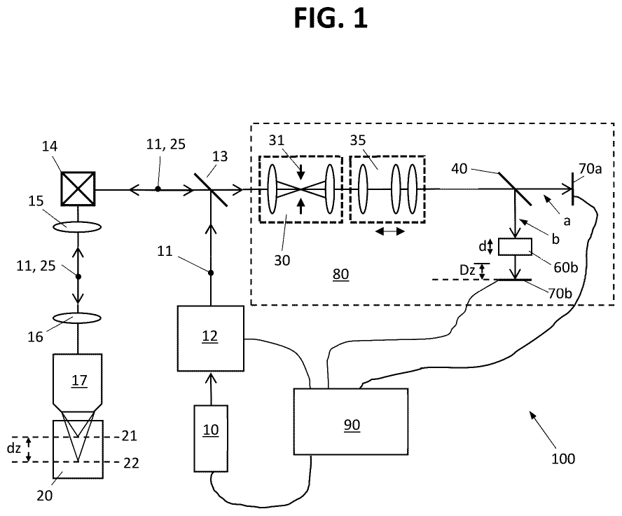

FIG. 1: shows a schematic illustration of one exemplary embodiment of a microscope according to the invention;

FIG. 2: shows a first schematically illustrated example of a manipulation device for axially displacing a focal region;

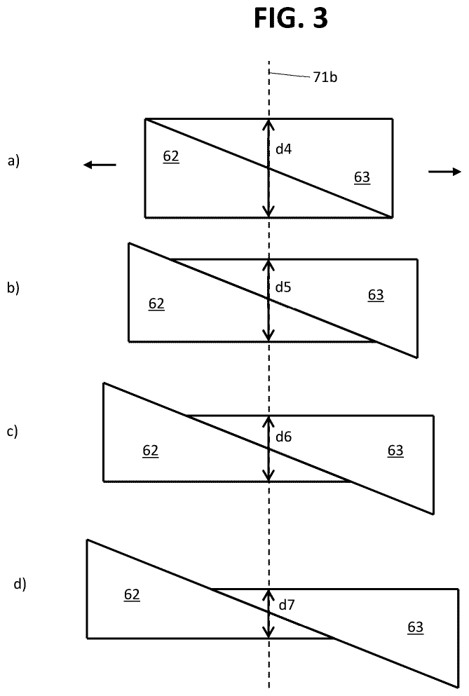

FIG. 3: shows a second schematically illustrated exemplary embodiment of a manipulation device for axially displacing a focal region;

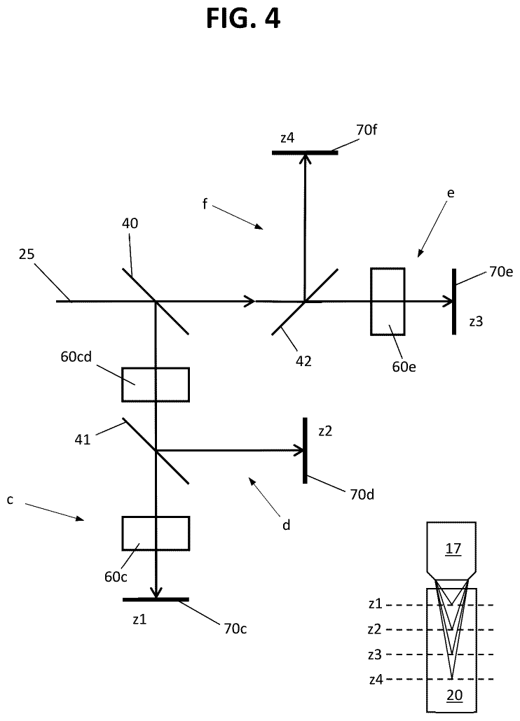

FIG. 4: shows a schematically shown part of an exemplary embodiment with four axial detection channels; and

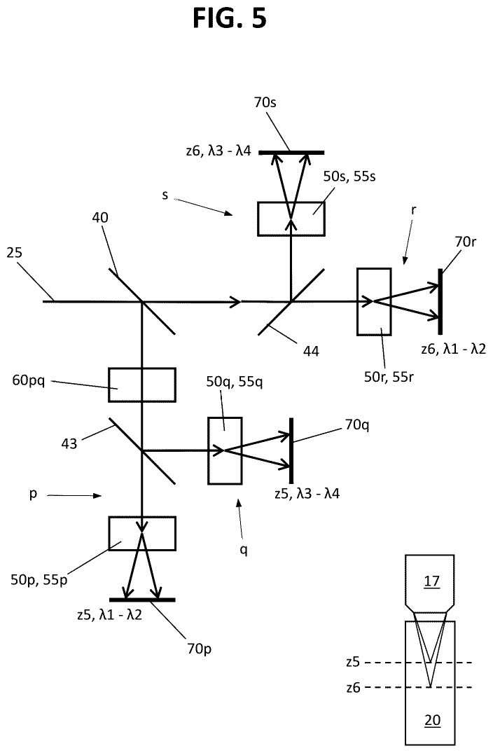

FIG. 5: shows a schematically shown part of an exemplary embodiment with two axial detection channels, each of which are separated into two spectrally different detection channels.

One exemplary embodiment of a microscope 100 according to the invention will be described with reference to FIG. 1.

According to the invention, the microscope 100 comprises a light source 10 for transmitting excitation light 11, an illumination beam path for guiding the excitation light 11 onto and/or into a sample 20, a scanning device 14 for varying a location on and/or in the sample 20 exposed to the excitation light 11, a detection unit 80 for detecting light 25 emitted from the sample 20 and a detection beam path with a microscope objective 17 for guiding at least a portion of the light 25 emitted from the sample 20 to the detection unit 80. According to the invention, a control unit 90 is present for controlling the scanning device 14 and the detection unit 80 and for evaluating measurement data from the detection unit 80.

The light source 10 can typically be a laser or a laser module, which has laser light with specifications suitable for fluorescence microscopy, in particular as regards intensity, spectral properties and temporal structure. In particular, the excitation light 11 may be electromagnetic radiation suitable for exciting fluorophores with which the sample 20 has been prepared.

In the exemplary embodiment shown, the illumination beam path, via which the excitation light 11 reaches onto and/or into the sample 20, is formed by the unit 12 for setting an axial depth of illumination and by the following further components: main colour splitter 13, scanner 14, scanning optical unit 15, tube lens 16, microscope objective 17.

The unit 12 for setting an axial depth of illumination may be a variably adjustable stop, by means of which the numerical aperture of the illumination is reduced in such a way that the axial extent of a focal volume in the sample 20 is increased. In the example shown, the focal volume in the sample 20 is axially extended in any case such that at least regions in the planes 21 and 22 in the sample 20 are sufficiently exposed to excitation light. Via the main colour splitter 13, the excitation light 11 reaches the scanner, which scans the excitation light 11 in two dimensions, for example, and which can comprise quasi-static and/or resonant galvanometric scanners. Via the scanning optical unit 15 and the tube lens 16, the excitation light 11 enters the microscope objective 17 and is focused by the latter into a focal volume in the sample 20, which in the example shown passes through at least the axial planes 21 and 22 of the sample 20.

As a result of the exposure to the excitation light 11, the sample 20 or the fluorophores with which the sample 20 has been prepared radiate light 25, in particular red-shifted fluorescence, that is guided via the detection beam path to the detection unit 80.

In the example shown, the light 25 to be detected passes back to the main colour splitter 13 via the microscope objective 17, the tube lens 16, the scanning optical unit 15 and the scanner 14. The main colour splitter 13 can be configured such that the light 25 to be detected is transmitted through the main colour splitter 13 and is subsequently incident on the detection unit 80, which serves to detect the light 25 emitted from the sample 20.

In the example shown, a first detection channel a with a first detector 70a and a second detection channel b with a second detector 70b are formed in the detection unit 80.

Furthermore, according to the invention, a beam splitter 40 is present in the example shown for guiding a portion of the light 25 to be detected into the second detection channel b. The beam splitter 40 can be a neutral-intensity splitter, for example a 50/50 neutral-intensity splitter. Other split ratios are, of course, possible.

In the example shown, an optical unit 35 of variable focal length, which can be a zoom optical unit, then is present in the detection unit 80 and serves to image the sample 20 with variable magnification on the detectors 70a, 70b.

Finally, in the second detection channel b in the example of FIG. 1, a schematically illustrated manipulation device 60b is present for axially displacing a focal region. In the example shown, this can be a glass plate of thickness d, which is arranged transversely to the optical axis of the beam path. The beam path is convergent in this region, i.e. in front of detector 70b. The glass plate 60b causes a refocusing into a slightly different plane. The glass plate 60b consequently serves to displace in the direction of the optical axis the focal region in the sample 20 that is imaged on the detector 70b.

What holds true approximately is that the axial offset Dz is described by the thickness d of the plate and the refractive index n of the plate material, as follows:

Dz=d×(n−1)/n.

With the lateral magnification V from the sample space 20 to the image region of the detection, this axial displacement Dz in the image region is converted into an axial offset dz of planes 21 and 22 in the sample 20 space, according to:

Dz=Dz/(V×V)

Thus, using the microscope 100 shown in FIG. 1, the sample planes 21, 22 axially spaced by dz can be imaged into the detection channels a, b. The spacing dz of the imaged sample planes can be varied by the parameters of the manipulation device 60b and by the magnification V. In the example of FIG. 1, the magnification V can be modified easily, accurately and continuously using the zoom optical unit 35.

The detection unit 80 of the microscope 100 in FIG. 1 also comprises an adjustable entrance pinhole 31 that is arranged in an intermediate image plane, formed by a pinhole optical unit 30, in the detection beam path. The pinhole 31 can be opened to such an extent for a measurement mode, in which a plurality of axially spaced planes of the sample 20 are imaged in the detection channels a, b, that light to be detected from both planes can pass through the pinhole 31 to the detection channels.

Detectors 70a, 70b are preferably SPAD arrays. In view of the signal-to-noise ratio, it is advantageous for SPAD arrays to be operated in a single photon counting mode (Geiger mode).

The pixels of detectors 70a, 70b can preferably be combined by binning, in particular to form super pixels, for example as described in WO 2020/20757 A1 in connection with FIGS. 2 to 4 and on page 20, penultimate paragraph, up to and including page 21, second paragraph.

This enables important advantages in view of data rate and measurement speed. The disclosure of FIGS. 2 to 4 and page 20, penultimate paragraph, up to and including page 21, second paragraph, of WO 2020/20757 A1 shall also be incorporated in the present application. FIG. 3 and FIG. 4 of WO 2020/20757 A1 show a binning of SPAD pixels that is advantageous for image scanning, with the active region in FIG. 3 being smaller than in FIG. 4. The active region may correspond to a specific pinhole size. In principle, the pinhole size for the detection in different planes and consequently in detection channels a and b can be selected to be the same or different. It also depends on the selected objective and the system magnification.

Finally, it is also preferable for pixels to be able to be set either actively or passively on an individual basis in the SPAD arrays 70a, 70b, as likewise described in WO 2020/20757 A1.

Consequently, variable pinholes can be realized by the SPAD arrays 70a, 70b; this is advantageous in particular in connection with the zoom system 35, by means of which a size of the pinholes can be roughly adjusted.

Then again, the zoom system 35 can serve to match the PSF to the respective detector 70a, 70b such that a dynamic range of the relevant detector 70a, 70b can be optimally used. Each axial plane can moreover be assigned its own pinhole with an individualized size, i.e. the degree of confocality can be set on an individual basis for the respective detection channel a, b.

Finally, to compensate for fill factors of less than 1, it is also preferable for a respective microlens array to be arranged in front of the SPAD arrays 70a, 70b.

As described, electronic pinholes can be created with two-dimensionally spatially resolving detectors, in particular with SPAD arrays. Alternatively, integrating sensors such as photomultipliers (PMT) can also be used, wherein a physical pinhole would have to be attached upstream thereof in the respective detection channel. This also works but is more complex and less flexible. PMTs with fibre bundles can also be used. However, the pinhole size can only be set comparatively roughly in this case. Confocal sectioning could then be set substantially by the optical unit of variable focal length, e.g. zoom 35 in FIG. 1, only. In contrast, in the case of a SPAD array, an electronic pinhole created thereby can be used in combination with the zoom 35. Both can be controlled by a control unit 90, depending on the microscope objective 17, and a desired resolution and the respective measuring method used.

Data quality can be significantly improved by using methods such as convolutions. Novel methods based on machine learning or deep learning can also be used directly and with advantage. So-called multiplexing methods, such as those established for the airyscan sensor [3], can also be used for axially spaced planes. The speed of recording three-dimensional images of a sample can thus be increased further, and the flexibility in the use of the sensor pixels can be exploited very advantageously here, as in the confocal mode.

Advantageously, methods for increasing the depth of field, for instance as described in EP 3650905 A1, can also be used with the microscope according to the invention. The measurement data in two planes can be obtained simultaneously using the microscope according to the invention.

Then the microscope according to the invention can also advantageously be used to perform methods for FLIM or FLI(S) M evaluation. In particular, simultaneous FLI(S) M imaging can be performed in a plurality of planes, for example in n planes.

Finally, the microscope according to the invention advantageously also renders possible single-shot 3D methods with double capture range.

In the microscope shown in FIG. 1, the axial spacing dz of the planes 21 and 22 in the sample 20 imaged in the detection channels a and b depends on the parameters of the manipulation device 60b, on the thickness d and the refractive index n of the glass plate and on the magnification V in the example. The magnification V can be modified using the zoom system 35. Greater flexibility as regards the variation of the axial spacing dz is achieved if parameters of the manipulation device can also be modified. Examples for which this is possible are explained in connection with FIGS. 2 and 3.

FIG. 2 schematically shows a manipulation device which is in the form of a stepped glass plate 61 and which can be positioned variably relative to the optical axis 71b, for example of the detection channel b. In the situation shown in FIG. 2, a region of the stepped glass plate 61 of thickness d2 is in the beam path and effective there. By way of example, other areas with thicknesses d1 and d3 are shown; they can each be positioned in the beam path by displacing the stepped glass plate 61 transversely to the optical axis 71b in the direction indicated by the double-headed arrow.

Similar properties as those of the stepped glass plate 61 of FIG. 2 can be achieved with an interchanger that can be used to position different glass plates, for example glass plates of different thicknesses and/or with different refractive indices, in the beam path 71b.

Even greater flexibility is possible for setting the axial spacings if the effective thickness of a glass component in the beam path can be adjusted continuously. An example to this end is illustrated in FIG. 3. The manipulation device in FIG. 3 is formed by two glass wedges 62 and 63, which are each displaceable relative to the optical axis 71b (mainly perpendicular to the optical axis 71b and also slightly in the direction of the optical axis 71b) such that different effective thicknesses d4 (FIG. 3a), d5 (FIG. 3b), d6 (FIG. 3c) and d7 (FIG. 3d) can be realized. The two glass wedges 62 and 63 can be actuated via motor components that can be controlled by the control unit 90.

The detection channels of the detection unit 80 of the microscope according to the invention can be configured in numerous different variants, wherein in particular the detection of axially spaced planes can be combined with a spectrally resolved detection. Two examples thereof will be described in connection with FIGS. 4 and 5.

FIG. 4 shows a variant in which a total of four axially spaced planes z1, z2, z3 and z4 in the sample 20 are observed in detection channels c, d, e and f respectively. For this purpose, a first beam splitter 40, a second beam splitter 41 and a third beam splitter 42 are present, which can advantageously each be 50/50 beam splitters.

A respective detector 70c, 70d, 70e and 70f is present in detection channels c, d, e and f, as shown schematically in FIG. 4. Advantageously, each of these detectors can be a SPAD array.

The component beam reflected off the first beam splitter 40 in FIG. 4 is incident on the second beam splitter 41, by means of which the component beam is split further among detection channels c and d, after passing through a manipulation device 60cd that is effective for detection channels c and d. In detection channel c there is a further manipulation device 60c, which serves to suitably set the axial plane z1 detected by the detector 70c. The detector 70d images the axial plane z2. Thus the manipulation devices 60cd and 60c are effective for channel c. Only the manipulation device 60cd is effective for detection channel d.

The component beam transmitted through the first beam splitter 40 in incident on the third beam splitter 42, by means of which this component beam is split among detection channels e and f. In detection channel e there is moreover a manipulation device 60e, which serves to suitably set the axial position of the axial plane z3 detected by the detector 70e. The detector 70f images the axial plane z4.

The manipulation devices 60cd, 60c and 60e can each be glass plates. However, they may also be formed by any other embodiment described here of a manipulation device for axially displacing a focal region.

The manipulation devices 60e and 60cd are dimensioned such that the focal region is displaced differently thereby. Otherwise, z2 and z3 would coincide, and this is not desirable here. For instance, should the manipulation devices 60e and 60cd be formed from glass plates of the same material, they would be of different thicknesses.

Another example for a configuration of the detection channels is shown in FIG. 5, wherein two axially spaced planes z5 and z6 are spectrally resolved in each case here. The sample plane z5 is imaged in spectrally resolved fashion in detection channels p and q, and the sample plane z6 is imaged in spectrally resolved fashion in detection channels r and s. For this purpose, a beam splitter 40, which might be a 50/50-neutral-intensity splitter as in FIG. 4, and also a first colour splitter 43 and a second colour splitter 44 are present. A respective detector 70p, 70q, 70r and 70s is present in detection channels p, q, r and s, as shown schematically in FIG. 5. Advantageously, each of these detectors can be a SPAD array.

The component beam reflected off the beam splitter 40 is incident on the first colour splitter 43, by means of which the component beam is spectrally split among detection channels p and q, after passing through a manipulation device 60pq that is effective for detection channels p and q. The component beam passing through the beam splitter 40 is incident on a second colour splitter 44, by means of which this component beam is split spectrally among detection channels r and s.

The sample plane z5 is imaged in detection channels p and q, also caused by the axial displacement of the manipulation device 60pq. The sample plane z6 is imaged in detection channels r and s.

The colour splitters 43 and 44 may be identical in the exemplary embodiment shown. The colour splitters 43 and 44 can also be colour gradient splitters, in which a change in a limit wavelength is achieved by mechanical displacement.

In the example shown, a first portion λ1 to λ2 of the spectrum of the light 25 to be detected can be detected in detection channels p and r, and a second portion λ3 to λ4 of the spectrum of the light 25 to be detected can be detected in detection channels q and s.

Finally, in the example shown, a dispersion unit 50p, 50q, 50r and 50s, each with at least one dispersive device 55p, 55q, 55r and 55s, is present in each of spectral detection channels p, q, r and s. The dispersive devices 55p, 55q, 55r, 55s each serve for spectrally separating the light 25 to be detected and can typically be formed by a diffractive or refractive component. The dispersion units 50p, 50q, 50r and 50s can each contain further components such as filters, apertures, lenses, in particular cylindrical lenses, or other optical components.

In an expedient modification of the arrangement of FIG. 4, where the beam splitters 41, 42 are neutral-intensity splitters, the beam splitters 41, 42 can be extended by dispersion prisms such that all detectors 70c-f receive for example the same spectral range, albeit now in spectrally resolving fashion.

Distributing the entire spectrum among a plurality of detectors, as in FIG. 5, may then be no longer necessary if sufficiently large two-dimensionally resolving detectors are available, i.e. detectors with a sufficiently large number of pixels and/or suitable geometric arrangement.

The modification of the arrangement from FIG. 4 mentioned here may be advantageous in this case.

### LIST OF REFERENCE SIGNS

10 Light source, laser module
12 Unit for setting an axial depth of illumination
11 Excitation light
13 Main colour splitter
14 Scanner
15 Scanning optical unit
16 Tube lens
17 Microscope objective
20 Sample
21 First plane in sample 20
22 Second plane in the sample 20
25 Light emitted from sample 20 as a result of exposure to excitation light 11
30 Pinhole optical unit
31 Adjustable pinhole
35 Optical unit of variable focal length, zoom optical unit
40 Beam splitter, neutral-intensity splitter
41 Beam splitter, neutral-intensity splitter
42 Beam splitter, neutral-intensity splitter
43 Beam splitter, colour splitter
50p Dispersion unit in detection channel p
50q Dispersion unit in detection channel q
50r Dispersion unit in detection channel r
50s Dispersion unit in detection channel s
55p Dispersive device in detection channel p
55q Dispersive device in detection channel q
55r Dispersive device in detection channel r
55s Dispersive device in detection channel s
60b Manipulation device for axially displacing a focal region
60cd Manipulation device for axially displacing a focal region, effective for detection channels c and d
60c Manipulation device for axially displacing a focal region, effective for detection channel c
60e Manipulation device for axially displacing a focal region, effective for detection channel e
60pq Manipulation device for axially displacing a focal region, effective for detection channels p and q
61 Stepped glass plate
62 First glass wedge
63 Second glass wedge
70a Detector in (first) detection channel a, SPAD array
70b Detector in (second) detection channel b, SPAD array
70c Detector in detection channel c, SPAD array
70d Detector in detection channel d, SPAD array
70e Detector in detection channel e, SPAD array
70f Detector in detection channel f, SPAD array
70p Detector in detection channel p, SPAD array
70q Detector in detection channel q, SPAD array
70r Detector in detection channel r, SPAD array
70s Detector in detection channel s, SPAD array
71b Optical axis
80 Detection unit
a Detection channel, first detection channel
b Detection channel, second detection channel
C Detection channel
d Detection channel
e Detection channel
f Detection channel
p Detection channel
q Detection channel
r Detection channel
S Detection channel
dZ Axial offset in the sample space
Dz Axial offset in the image space
d1 First thickness of stepped glass plate 61
d2 Second thickness of stepped glass plate 61
d3 Second thickness of stepped glass plate 61
d4 First effective thickness of the pair of glass wedges 62, 63
d5 Second effective thickness of the pair of glass wedges 62, 63
d6 Third effective thickness of the pair of glass wedges 62, 63
d7 Fourth effective thickness of the pair of glass wedges 62, 63
d8 Fifth effective thickness of the pair of glass wedges 62, 63
z1 z-coordinate of the plane in sample 20 imaged on the detector 70c
z2 z-coordinate of the plane in sample 20 imaged on the detector 70d
z3 z-coordinate of the plane in sample 20 imaged on the detector 70e
z4 z-coordinate of the plane in sample 20 imaged on the detector 70f
z5 z-coordinate of the plane in sample 20 imaged on the detectors 70p and 70q
z6 z-coordinate of the plane in sample 20 imaged on the detectors 70r and 70s
λ1 to λ2 Wavelength range detected in detection channels p and r
λ3 to λ4 Wavelength range detected in detection channels q and s.

### REFERENCES

[1] Tsang et al., https://doi.org/10.1364/BOE.417286
[2] Zhao et al., https://doi.org/10.1364/BOE.491538
[3] https://www.zeiss.com/microscopy/de/produkte/lichtmikroskope/konfokale-mikroskope/lsm-980-mit-airyscan-2.html
[4] LSM 5 LIVE by ZEISS

1. Microscope comprising:
a light source for transmitting excitation light,
an illumination beam for guiding the excitation light onto and/or into a sample,
a scanning device for varying a location on and/or in the sample exposed to the excitation light,
a detection unit for detecting light emitted from the sample, a detection beam path with a microscope objective for guiding at least a portion of the light emitted from the sample to the detection unit and a control unit for controlling the scanning device and the detection unit and for evaluating measurement data from the detection unit,
wherein in the detection unit, a first detection channel with at least one first detector and at least one further detection channel are formed, with each further detection channel comprising at least one detector, wherein the detection unit, includes at least one beam splitter in each case for guiding a portion of the light emitted from the sample into a respective further detection channel, and
least one of the detection channels, includes a manipulation device for axial displacement of a focal region in order to image axially spaced sample planes in at least two detection channels.

2. Microscope according to claim 1,
wherein the detection unit, includes an optical unit of variable focal length for imaging the sample with variable magnification onto the detectors.

3. (canceled)

4. Microscope according to claim 1,
wherein in at least one of the detection channels, the manipulation device comprises an interchanger with different glass plates that is arranged in a convergent part of the detection beam path, each glass plate having a different thickness and/or the glass materials of each glass plate having a different refractive index.

5. Microscope according to claim 1,
wherein in at least one of the detection channels, the manipulation device comprises a stepped glass plate that is arranged in a convergent part of the detection beam path, said stepped glass plate being variably positionable in the detection-beam beam path in order to set different optically effective thicknesses transverse to an optical axis.

6. Microscope according to claim 1,
wherein in at least one of the detection channels, the manipulation device comprises two glass wedges to be arranged in a convergent part of the detection beam path, said glass wedges being displaceable relative to each other and relative to an optical axis in order to set different optically effective thicknesses continuously.

7. Microscope according to claim 1,
wherein in at least one of the detection channels, the manipulation device comprises a mini-telescope, in particular an adjustable mini-telescope.

8. (canceled)

9. Microscope according to claim 1,
wherein the illumination path includes a unit for setting an axial depth of illumination.

10. Microscope according to claim 9,
in that wherein the unit for setting an axial depth of illumination comprises an adjustable stop for setting a beam diameter of the excitation light.

11. Microscope according to claim 9,
wherein the unit for setting an axial depth of illumination is configured to generate a plurality of axially spaced focal points in the sample.

12. Microscope according to claim 9,
wherein the unit for setting an axial depth of illumination comprises at least one diffractive component.

13. Microscope according to claim 9,
wherein the unit for setting an axial depth of illumination is configured to defocus the excitation light in such a way that a focus of an excitation beam, is located between two detection planes.

14. Microscope according to claim 1,
wherein the optical unit of variable focal length in each case images one and the same plane of the sample onto the detectors, independently of a focal length setting.

15. Microscope according to claim 1,
wherein the optical unit of variable focal length comprises a zoom optical unit and/or a lens interchange system, with which the magnification can be set to a plurality of discrete values.

16. Microscope according to 1,
wherein the detection unit comprises an aperture stop with an adjustable size.

17. Microscope according to claim 1,
wherein at least one of the beam splitters is a neutral-intensity splitter.

18-20. (canceled)

21. Microscope according to claim 1,
wherein at least one of the detectors is a two-dimensionally spatially resolving detector, and wherein in at least one of the two-dimensionally spatially resolving detectors, pixels can be individually set either active or passive.

22. Microscope according to claim 1,
wherein at least one of the detectors is a two-dimensionally spatially resolving detector, and wherein a multi-lens array is arranged in front of at least one of the detectors.

23. Microscope according to claim 1,
wherein at least one of the detectors comprises one or more photomultipliers.

24. Microscope according to claim 1,
wherein at least one of the beam splitters is a colour splitter which forms at least two spectrally different detection channels.

25. Microscope according to claim 24,
wherein at least one of the detection channels, includes a dispersive device for spectrally separating at least a portion of the light emitted from the sample.

26. Microscope according to claim 24,
wherein a dispersive device for spectrally separating light to be detected, effective in a plurality of detection channels, is present.

27. Microscope according to claim 26,
wherein at least one of the dispersive devices for spectrally separating at least a portion of the light emitted from the sample can be controlled and optionally activated, and
wherein the control unit is configured to control the dispersive device.
